(19) United States
(12) Patent Application Publication
(10) Pub. No.: US 2008/0084976 A1
(43) Pub. Date: Apr. 10, 2008

(54) CONTEXT-SENSITIVE COMMUNICATIONS FUNCTION

(75) Inventor: Ludwig Brackmann, Bonn (DE)

Correspondence Address: DARBY & DARBY P.C., P.O. BOX 770, Church Street Station, New York, NY, 10008-0770, US

(73) Assignee: Deutsche Telekom AG, Bonn (DE)

(21) Appl. No.: 11/866,227

(22) Filed: Oct. 2, 2007

(30) Foreign Application Priority Data
Oct. 7, 2006 (DE) 10 2006 047 464.3

(51) Int. Cl. H04M 11/00; G10L 15/04

(52) U.S. Cl. 379/93.25; 704/251; 704/E15.005

(57) ABSTRACT

A method and system are provided for automatically presenting information during a telephone conversation between two parties to a telephone call. A search term connected with parameters of the telephone connection or with the content of the telephone conversation is generated. A search request is generated from the search term in order to be transferred to a search function which will use the search term to search a volume of data. Information is returned as a search result and the information is presented to at least one of the parties to the conversation during the telephone call.

### CROSS REFERENCE TO RELATED APPLICATIONS

This application claims benefit to German Patent Application No. 10 2006 047 464.3, filed Oct. 7, 2006.

### FIELD

The present invention relates to a method for automatically presenting information during a telephone conversation between two parties during a telephone call.

### BACKGROUND

Everybody knows the problem that arises when one or both parties to a telephone call must quickly find and communicate information during the call, such as the telephone number of a third party. In cases similar to that of the missing telephone number, this problem is usually solved by one of the parties to the call searching the written notes he or she has currently at hand. However, these notes must actually be available to the respective party, and the information content of the notes is usually limited to a few facts and does not provide any answers to further questions.

German Patent DE 199 54 859 C2 describes an Internet telephony system, in which information on products events, or the like, is output to the communicating parties during a connection in accordance with stored subscriber profile data. The output information is supplemented with data that is generated as a function of analyzed speech data.

### SUMMARY

It is an aspect of the present invention to quickly and conveniently provide and present information which is of current interest to the party or parties to a telephone conversation and which is independent of profile data and to achieve this simply. Another aspect of the present invention is to provide a system for implementing the method.

In an embodiment, the present invention provides a method for automatically presenting information during a telephone conversation between two parties to a telephone call. The method includes the step of generating a search term connected with a parameter of a telephone connection or with a content of the telephone conversation. The method further includes the step of generating a search request from the search term. The method further includes the step of transferring the search term to a search function that uses the search term to search a volume: of data. The method further includes the step of returning information as a search result. The method further includes the step of presenting the information to at least one of the parties to the conversation during the telephone call.

### BRIEF DESCRIPTION OF THE DRAWINGS

Aspects of the present invention will now be described by way of exemplary embodiments with reference to the following drawings, in which:

FIG. 1 shows a “normal” telephone network for implementing the method according to an exemplary embodiment of the present invention; and

FIG. 2 shows a system including the Internet.

### DETAILED DESCRIPTION

A basic idea is to generate, during a telephone connection, a search request containing one or more search terms, to search an available volume of data using said search request, and to present the search result to at least one of the parties to the conversation. In this context, the “search term” feature is not restricted to words, but may also be used for numbers, such as network indicators or the like. The telephone connection may be either a connection via a fixed network or via a mobile telecommunications network, it being advantageous to have as: direct access as possible to the Internet via the network. The generation of search terms can be done in two different possible ways:

On the one hand, the search request may contain search terms that are derived automatically from parameters of the telephone connection. Such parameters may include the current location of one of the parties, or the location of the calling or called subscriber loop. Such a location is of particular interest because a number of other information items, such as the current environment or the social status, can be derived therefrom. The current locations of parties communicating via mobile telecommunications networks can be determined by the radio cells in which the communicating parties are located. Also known are mobile telephones that have GPS functionality and can provide location coordinates as a search term. When a fixed network subscriber is involved, the information available does not only include the area code. Rather, it is possible to use extensive databases, in which the location of a subscriber loop is stored with GPS accuracy. For example, network providers maintain databases from which mail addresses can be determined via the calling or called line identification. A mail address may in turn be used to search databases containing background information, for example on real property associated with the address and/or on the social environment. This background information can be used to derive search terms to be included in the search request. A multitude of information can also be derived from parameters including the duration of the call and/or the time at which the call is made. In addition, it is possible to determine the identity of the subscriber or subscribers using, for example, entries in telephone books, either public ones or non-public ones which may be stored, for example, in the telephone. Using the search function, information can then be retrieved about the subscribers.

On the other hand, a search term may be connected with the content of the telephone conversation in that the term is derived from the current topic of the conversation or even from a physical or emotional reaction expressed by one of the parties. It is understood that such expressions too are to be considered tinder the feature of “in connection with the telephone call. In such a case, a search term may be automatically filtered out of the conversation by an analysis function. However, the search term may also be actively input by one of the parties during the call via a voice or keypad command.

The so-generated search request, which is made up of search terms, is then transferred to a search function which uses the search request to search a volume of data that is accessible via the terminal device so that data can be transferred from the volume of data to the terminal device. The generation of search terms does not: need to be done in the terminal device. In the case of “normal” telephony, this is advantageously accomplished by a computer that is accessible over the network. In the case of Internet telephony, where powerful computers are used as terminal devices, search terms can be generated directly in the computer and transferred as a search request to a search engine running in parallel or on the network. The volume of data may be present in a database that is accessible over the network, such as the WWW, or in a database that can only be accessed decentrally by the respective terminal device, such as a telephone book.

It is known in particular from Internet search functions (search engines) that the returned search result is usable information which, in turn, may include a reference to an information source containing more detailed background information. In this case, the first information already allows conclusions to be drawn about the background information. The retrieved information and the reference to the information source are respectively presented to at least one of the parties to the connection during the telephone call.

The approach of the present invention has an advantage that the output information is of current interest to the parties to the connection and that it is independent of a stored subscriber profile. The generation of search terms in accordance with the present invention, and the transfer of such search terms to one or more accessible databases provides high flexibility for the method.

The returned information may also include the presentation of another option for communication. For example, it is possible to immediately establish a connection to a third party when one of the subscribers makes such a request. Such a request may, for example, be a voice command saying “conference with Mr. Miller”, which would automatically establish a conference call. In such a case, the data needed for communication is retrieved from an internal or centrally accessible database.

The present invention, which can be carried out also from a simple telephone, makes it possible provide a variety of attractive functionalities for the telephone user. In a particularly simple case, the function implemented in the terminal device accesses the volume of data of the internal telephone or address book, and outputs the data, in particular the telephone number; contained therein for a user for whom a request is being made. The name of the requested subscriber may previously be input by voice command after the function has been activated by voice or key command. This eliminates the known problem where one of the parties wishes to communicate a telephone number to the other party, but is unable to do so because he/she would first have to look it up in his/her electronic telephone book, which in turn is not possible without interrupting the connection. Now, the customer can press a key during the call, if necessary, and input the name of the requested subscriber to the function activated in this manner. The search function searches the volume of data for this information and, as a result, outputs the data to one or both parties by voice and/or by a text message, for example in the form of an SMS. The present invention provides obvious advantages even in this simple embodiment.

As already indicated, there are two different ways of determining the search term, which may also be combined. In a first variant, it is derived automatically from parameters of the telephone connection. As explained earlier, such parameters can be of different types, including, for example, the subscribers' network indicators, from which, in the first place, the current location of the subscribers can be derived. It is possible to offer quite general information in the form of an advertising message for the determined locations. For example, if both parties have the area code “0228” and the call is made in the evening, a restaurant located in the center of the city of Bonn may be displayed along with a telephone number for direct connection. Of course, it would be particularly effective to display such information if, in addition, the search were combined with a search term derived from the content of the conversation, for example, with “going out to eat”. If a subscriber calling from Düsseldorf using his/her area code “0211” makes a telephone call to Munich, i.e., to area code “089”, the system may display to the subscriber an airline company that provides flights on this route, and a hotel chain present in that city. The advertisements may also contain links leading directly to the service providers and allowing immediate reservation. In another embodiment, an interpreter service may be offered when an international telephone call is made. In addition to the time, the telephone connection parameters used may also include the duration of the current connection, or previous contacts via this connection. These parameters allow conclusions to be drawn about the current information needs of the parties to the conversation.

In another exemplary embodiment, a search term is input by one of the parties via an input device, in particular via the microphone or the keypad of his/her terminal device. This input may be made consciously in the form of targeted information, or unconsciously. In the case of an unconscious input, the search term is generated automatically by an analysis function from the conversation between the parties to the connection, in particular from spoken words or from behavioral features expressed by the parties during the conversation. In this case, the analysis function is activated immediately when the connection is established. It is advantageous to continuously repeat the search with new search terms during the conversation, so that the presented result is sufficiently current. Thus, the references presented change during the telephone call according to the content of the conversation. In the case of targeted information, it is advantageous if the party to the conversation activates this function as a user, for example, by pressing a key, and then enters the search term.

Although the present invention can be implemented in “conventional” telephony, it demonstrates its particular versatility especially when used in the now possible Internet telephony. Among other things, this is primarily due to the fact that the entire data volume of the web pages that are accessible via the World Wide Web is made available in this way and can be searched in a manner that is technically easy to implement. In addition, terminal devices capable of voice over IP offer a number of features similar to those provided by computers that can be used for this purpose. These include, in addition to the large main memory, also the large screen on which advertising banners can be displayed as search results particularly effectively, as well as the ease-of-use provided by the programs (clients).

A noteworthy example of such a client is “Skype”, which is a particularly highly developed client that provides a multitude of essential functions for voice and video communications, and instant messaging. Such voice over IP clients also have easy-to-use graphical user interfaces and can be updated at any time by downloading updates over the Internet. This allows the functions of the user interface to be adapted in a matter of seconds.

The Internet, as a still strongly expanding medium, offers the possibility of selecting from a large number of application programs anyway. In particular, in order to implement the search function, it is advantageous to use a conventional search engine, which searches the World Wide Web for the search term and returns links provided with some “accompanying” information. However, it is advantageous for such accompanying information to be distilled from the web pages behind the links. In a simple case, a fragment of a web page assumed to include a kind of a summary can be displayed along with the reference to background information, in particular, along with the link. In this connection, it is advantageous if the information presented in the form of a reference, in particular in the form of an advertising message.

Such advertising messages can be displayed on the screen, but can also be suitably presented by voice during the telephone call, in particular during an unimportant phase or during a pause.

Quite generally, the advertising space in the telephone medium can be sold to customers, as is known from Internet portals. Billing may be on a “per click” basis, as is also known. This makes it possible to open up a particularly attractive area of business. In a particularly preferable embodiment, an operator, in particular the provider of the voice over IP system, creates an affiliate system with which a multitude of partners are associated. The search is then carried out within the range of products and/or services offered by the partners, who, in turn, may create advertising banners containing meaningful information. Such advertising banners are displayed when corresponding search criteria are input. Clicking on the banner of a partner: will cause the data content associated with the partner, in particular the offered range of products and/or services, to be presented, in particular to be displayed on the screen. In addition, it is possible to establish a direct connection to the partner for ordering purposes, it being possible for the connection to be a data or voice connection.

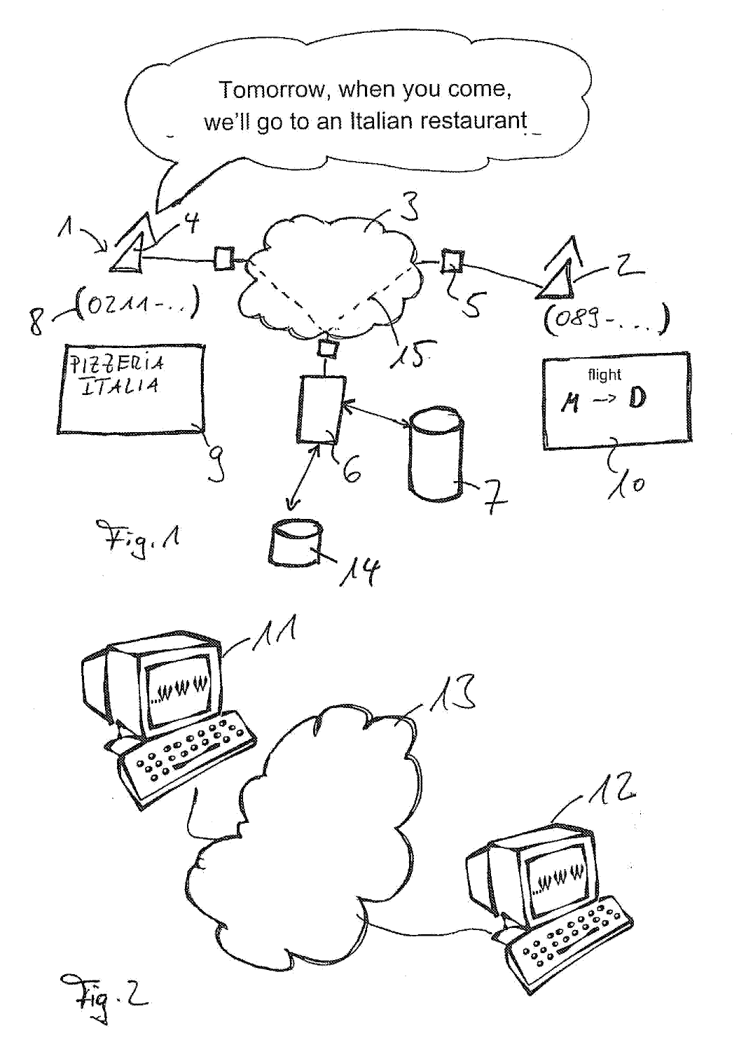

FIG. 1 schematically illustrates a typical situation, where a subscriber 1 in Düsseldorf has a telephone conversation with a subscriber 2 in Munich via a telephone network 3. The respective terminal devices 4 are connected to telephone network 3 via switching centers 5. Connection 15 is looped via a server 6 having access to two databases 7 and 14.

Via the local area codes 8 of the subscribers, server 6 is informed of the locations of subscribers 1 and 2, namely Munich and Düsseldorf. In the course of the conversation, subscriber 1 says “Tomorrow, when you come, we'll go to an Italian restaurant”. This sentence is captured and analyzed by an analysis module running in server 6. The analysis module recognizes, first of all, that the sentence was uttered by subscriber 1 from Düsseldorf. It analyzes that subscriber B will tomorrow have to travel from Munich to Düsseldorf and the two subscribers are planning to go out to eat at an Italian restaurant. Therefore, it accesses database 7 and gets to a flight booking service that offers flights for this route. Server 6 may also initially access a database 14 in order, for example, to derive further background information on the social environment from the information about the current location. Search terms can be derived from the background information and then be used to generate a search request for database 7. The result is presented to subscriber 2 on display 9 of his/her terminal device, whereas subscriber 1 is provided, on his/her display 10, with information about Italian restaurants in his/her vicinity.

In contrast, FIG. 2 shows two subscribers who are connected to Internet 13 by their computers 11 and 12, respectively. Programs allowing Internet telephony via voice over IP are running on computers 11 and 12. The locations of computers 11 and 12 can be determined by the network connection information.

When subscriber 11 now utters the above-mentioned sentence, then analysis functions running on computers 11 and 12 analyze the content and transfer the search terms to a search engine also running on computers 11 and 12, respectively. In the present case, these search terms are, for example, “Düsseldorf”, “going out to eat”, and “Italian restaurant” on one side, and “travel” and “Munich Düsseldorf” on the other side. The search functions display the results on the respective screens of computers 11 and 12.

Using the inventive method, useful information on specific locations which was obtained based on the network connection information can be output to the user. In another embodiment, the location information derived from the network connection information can be used to search other databases. In that case, the information output to the user is connected with the environment in which the user is located or moves. These embodiments can be combined with the possibility of actively inputting search terms.

### Context-Sensitive Communications Function

The present invention relates to a method for automatically presenting information during a telephone conversation between two parties during a telephone call.

Everybody knows the problem that arises when one or both parties to a telephone call must quickly find and communicate information during the call, such as the telephone number of a third party. In cases similar to that of the missing telephone number, this problem is usually solved by one of the parties to the call searching the written notes he or she has currently at hand. However, these notes must actually be available to the respective party, and the information content of the notes is usually limited to a few facts and does not provide any answers to further questions.

German Patent DE 199 54 859 C2 discloses an Internet telephony system, in which information on products, events, or the like, is output to the communicating parties during a connection in accordance with stored subscriber profile data. The output information is supplemented with data that is generated as a function of analyzed speech data.

It is an object of the present invention to quickly and conveniently provide and present information which is of current interest to the party or parties to a telephone conversation and which is independent of profile data, and to achieve this object using simple means. Another object of the present invention is to provide a system for implementing the method.

These objects are achieved by the method having the features of claim 1 and the system set forth in claim 10. Advantageous embodiments of the present invention are set forth in the respective dependent claims.

The basic idea of the present invention is to generate, during a telephone connection, a search request containing one or more search terms, to search an available volume of data using said search request, and to present the search result to at least one of the parties to the conversation. In this context, the “search term” feature is not restricted to words, but may also be used for numbers, such as network indicators or the like. The telephone connection may be either a connection via a fixed network or via a mobile telecommunications network, it being advantageous to have as direct access as possible to the Internet via the network. The generation of search terms can be done in two different possible ways:

On the one hand, the search request may contain search terms that are derived automatically from parameters of the telephone connection. Such parameters may include the current location of one of the parties, or the location of the calling or called subscriber loop. Such a location is of particular interest because a number of other information items, such as the current environment or the social status, can be derived therefrom. The current locations of parties communicating via mobile telecommunications networks can be determined by the radio cells in which the communicating parties are located. Also known are mobile telephones that have GPS functionality and can provide location coordinates as a search term. When a fixed network subscriber is involved, the information available does not only include the area code. Rather, it is possible to use extensive databases, in which the location of a subscriber loop is stored with GPS accuracy. For example, network providers maintain databases from which mail addresses can be determined via the calling or called line identification. A nail address may in turn be used to search databases containing background; information, for example on real property associated with the address and/or on the social environment. This background information can be used to derive search terms to be included in the search request. A multitude of information can also be derived from parameters including the duration of the call and/or the time at which the call is made. In addition, it is possible to determine the identity of the subscriber or subscribers using, for example, entries in telephone books, either public ones or non-public ones which may be stored, for example, in the telephone. Using the search function, information can then be retrieved about the subscribers.

On the other hand, a search term may be connected with the content of the telephone conversation in that the term is derived from the current topic of the conversation or even from a physical or emotional reaction expressed by one of the parties. It is understood that such expressions too are to be considered under the feature of “in connection with the telephone call. In such a case, a search term may be automatically filtered out of the conversation by an analysis unction. However, the search term may also be actively input by one of the parties during the call via a voice or keypad command.

The so-generated search request, which is made up of search terms, is then transferred to a search function which uses the search request to search a volume of data that is accessible via the terminal device so that data can be transferred from the volume of data to the terminal device. The generation of search terms does not need to be done in the terminal device. In the case of “normal” telephony, this is advantageously accomplished by a computer that is accessible over the network. In the case of Internet telephony, where powerful computers are used as terminal devices, search terms can be generated directly in the computer and transferred as a search request to a search engine running in parallel or on the network. The volume of data may be present in a database that is accessible over the network, such as the WWW, or in a database that can only be accessed decentrally by the respective terminal device, such as a telephone book.

It is known in particular from Internet search functions (search engines) that the returned search result is usable information which, in turn, may include a reference to an information source containing more detailed background information. In this case, the first information already allows conclusions to be drawn about the background information. The retrieved information and the reference to the information source are respectively presented to at least one of the parties to the connection during the telephone call.

The approach of the present invention has the particular advantage that the output information is of current interest to the parties to the connection and that it is independent of a stored subscriber profile. The generation of search terms in accordance with the present invention, and the transfer of such search terms to one or more accessible databases provides high flexibility for the method.

The returned information may also include the presentation of another option for communication. For example, it is possible to immediately establish a connection to a third party when one of the subscribers makes such a request. Such a request may, for example, be a voice command saying “conference with Mr. Miller”, which would automatically establish a conference call. In such a case, the data needed for communication is retrieved from an internal or centrally accessible database.

The present invention, which can be carried out also from a simple telephone, makes it possible provide a variety of attractive functionalities for the telephone user. In a particularly simple case, the function implemented in the terminal device accesses the volume of data of the internal telephone or address book, and outputs the data, in particular the telephone number, contained therein for a user for whom a request is being made. The name of the requested subscriber may previously be input by voice command after the function has been activated by voice or key command. This eliminates the known problem where one of the parties wishes to communicate a telephone number to the other party, but is unable to do so because he/she would first have to look it up in his/her electronic telephone book, which in turn is not possible without interrupting the connection. Now, the customer can press a key during the call, if necessary, and input the name of the requested subscriber to the function activated in this manner. The search function searches the volume of data for this information and, as a result, outputs the data to one or both parties by voice and/or by a text message, for example in the form of an SMS. The present invention provides obvious advantages even in this simple embodiment.

As already indicated, there are two different ways of determining the search term, which may also be combined. In a first variant, it is derived automatically from parameters of the telephone connection. As explained earlier, such parameters can be of different types, including, for example, the subscribers' network indicators, from which, in the first place, the current location of the subscribers can be derived. It is possible to offer quite general information in the form of an advertising message for the determined locations. For example, if both parties have the area code “0228” and the call is made in the evening, a restaurant located in the center of the city of Bonn may be displayed along with a telephone number for direct connection. Of course, it would be particularly effective to display such information if, in addition, the search were combined with a search term derived from the content of the conversation, for example, with “going out to eat” If a subscriber calling from Düsseldorf using his/her area code “0211” makes a telephone call to Munich, i.e., to area code “089”, the system may display to the subscriber an airline company that provides flights on this route, and a hotel chain present in that city. The advertisements may also contain links leading directly to the service providers and allowing immediate reservation. In another embodiment, an interpreter service may be offered when an international telephone call is made. In addition to the time, the telephone connection parameters used may also include the duration of the current connection, or previous contacts via this connection. These parameters allow conclusions to be drawn about the current information needs of the parties to the conversation.

In another preferred embodiment, a search term is input by one of the parties via an input device, in particular via the microphone or the keypad of his/her terminal device. This input may be made consciously in the form of targeted information, or unconsciously. In the case of an unconscious input, the search term is generated automatically by an analysis function from the conversation between the parties to the connection, in: particular from spoken words or from behavioral features expressed by the parties during the conversation. In this case, the analysis function is activated immediately when the connection is established. It is advantageous to continuously repeat the search with new search terms during the conversation, so that the presented result is sufficiently current. Thus, the references presented change during the telephone call according to the content of the conversation. In the case of targeted information, it is advantageous if the party to the conversation activates this function as a user, for example, by pressing a key, and then enters the search term.

Although the present invention can be implemented in “conventional” telephony, it demonstrates its particular versatility especially when used in the now possible Internet telephony. Among other things, this is primarily due to the fact that the entire data volume of the web pages that are accessible via the World Wide Web is made available in this way and can be searched in a manner that is technically easy to implement. In addition, terminal devices capable of voice over IP offer a number of features similar to those provided by computers that can be used for this purpose. These include, in addition to the large main memory, also the large screen on which advertising banners can be displayed as search results particularly effectively, as well as the ease-of-use provided by the programs (clients).

A noteworthy example of such a client is “Skype”, which is a particularly highly developed client that provides a multitude of essential functions for voice and video communications, and instant messaging. Such voice over IP clients also have easy-to-use graphical user interfaces and can be updated at any time by downloading updates over the Internet. This allows the functions of the user interface to be adapted in a matter of seconds.

The Internet, as a still strongly expanding medium, offers the possibility of selecting from a large number of application programs anyway. In particular, in order to implement the search function, it is advantageous to use a conventional search engine, which searches the World Wide Web for the search term and returns links provided with some “accompanying” information. However, it is advantageous for such accompanying information to be distilled from the web pages behind the links. In a simple case, a fragment of a web page assumed to include a kind of a summary can be displayed along with the reference to background information, in particular, along with the link. In this connection, it is advantageous if the information presented in the form of a reference, in particular in the form of an advertising message.

Such advertising messages can be displayed on the screen, but can also be suitably presented by voice during the telephone call, in particular during an unimportant phase or during a pause.

Quite generally, the advertising space in the telephone medium can be sold to customers, as is known from Internet portals. Billing may be on a “per click” basis, as is also known. This makes it possible to open up a particularly attractive area of business. In a particularly preferable embodiment an operator, in particular the provider of the voice over IP system, creates an affiliate system with which a multitude of partners are associated. The search is then carried out within the range of products and/or services offered by the partners, who, in turn, may create advertising banners containing meaningful information. Such advertising banners are displayed when corresponding search criteria are input. Clicking on the banner of a partner will cause the data content associated with the partner, in particular the offered range of products and/or services, to be presented, in particular to be displayed on the screen. In addition, it is possible to establish a direct connection to the partner for ordering purposes, it being possible for the connection to be a data or voice connection.

Two specific embodiments of the present invention will be described below with reference to FIGS. 1 and 2. In the drawing,

FIG. 1 shows a “normal” telephone network for implementing the method according to the present invention; and

FIG. 2 shows a system including the Internet.

FIG. 1 schematically illustrates a typical situation, where a subscriber 1 in Düsseldorf has a telephone conversation with a subscriber 2 in Munich via a telephone network 3. The respective terminal devices 4 are connected to telephone network 3 via switching centers 5. Connection 15 is looped via a server 6 having access to two databases 7 and 14.

Via the local area codes 8 of the subscribers, server 6 is informed of the locations of subscribers 1 and 2, namely Munich and Düsseldorf. In the course of the conversation, subscriber 1 says “Tomorrow, when you come, we'll go to an Italian restaurant”. This sentence is captured and analyzed by an analysis module running in server 6. The analysis module recognizes, first of all, that the sentence was uttered by subscriber 1 from Düsseldorf. It analyzes that subscriber 13 will tomorrow have to travel from Munich to Düsseldorf, and the two subscribers are planning to go out to eat at an Italian restaurant. Therefore, it accesses database 7 and gets to a flight booking service that offers flights for this route. Server 6 may also initially access a database 14 in order, for example, to derive further background information on the social environment from the information about the current location. Search terms can be derived from the background information and then be used to generate a search request for database 7. The result is presented to subscriber 2 on display 9 of his/her terminal device, whereas subscriber 1 is provided, on: his/her display 10, with information about Italian restaurants in his/her vicinity.

In contrast, FIG. 2 shows two subscribers who are connected to Internet 13 by their computers 11 and 12, respectively. Programs allowing internet telephony via voice over IP are running on computers 11 and 12. The locations of computers 11 and 12 can be determined by the network connection information.

When subscriber 11 now utters the above-mentioned sentence, then analysis functions running on computers 11 and 12 analyze the content and transfer the search terms to a search engine also running on computers 11 and 12, respectively. In the present case, these search terms are, for example, “Düsseldorf”, “going out to eat” and “Italian restaurant” on one side, and “travel” and “Munich Düsseldorf” on the other side. The search functions display the results on the respective screens of computers 11 and 12.

Using the inventive method, useful information on specific locations which was obtained based on the network connection information can be output to the user. In another embodiment, the location information derived from the network connection information can be used to search other databases. In that case, the information output to the user is connected with the environment in which the user is located or moves. These embodiments can be combined with the possibility of actively inputting search terms.

1-10. (canceled)

11: A method for automatically presenting information during a telephone conversation between first and second parties to a telephone call, comprising:
generating a search term connected with at least one of a parameter of a telephone connection and a content of the telephone conversation;
generating a search request for the search term;
transferring the search term to a search function;
searching, by the search function, a volume of data using the search term;
returning information as a search result; and
presenting the information to at least one of the parties to the conversation during the telephone call.

12: The method recited in claim 11, wherein the information includes a reference to an information source containing background information, the background information including a link to a further data source, the information allowing conclusions to be drawn about the background information.

13: The method recited in claim 11, wherein the information includes at least one of an option for communication and a subscriber information, the subscriber information stored in an address book of a terminal device and including a telephone number of the subscriber.

14: The method recited in claim 11, wherein the parameter of the telephone connection includes call data derived directly or indirectly from an information relating to the connection.

15: The method recited in claim 14, wherein the call data includes subscriber line data of one of the subscribers.

16: The method recited in claim 11, wherein the generating a search term includes inputting the search term by at least one of the communicating parties via an input device.

17: The method recited in claim 16, wherein the input device includes at least one of a microphone and a keypad of a terminal device.

18: The method recited in claim 11, wherein the search term is generated from spoken words automatically by an analysis function from the conversation between the parties to the connection.

19: The method recited in claim 11, wherein the search function includes a search engine that searches the data volume, the data volume including a web page that is accessible via a World Wide Web.

20: The method recited in claim 11, wherein the information includes a reference to an information source, the reference to an information source including at least one of a link to a web page, a fragment of the web page and a summary of the content of a web page.

21: The method as recited in claim 11, further comprising connecting at least one of the parties to the information source by inputting a command.

22: The method recited in claim 21, wherein the command includes at least one of a keypad command and a voice command.

23: A system, comprising:
a first and a second locatable terminal device configured to make telephone calls and present information during a telephone call;
a network configured to transmit a telephone call between the locatable terminal devices;
a module configured to generate a search term from at least one of a parameter of a telephone connection and a content of the telephone conversation conducted between the two locatable terminal devices; and
an arrangement including a search function configured to use the search term to search a volume of data and transfer a search result to at least one of the locatable terminal devices for display.

24: The system recited in claim 23, wherein the parameter of the telephone connection includes call data derived directly or indirectly from an information relating to the connection.

25: The system recited in claim 23, wherein the search term is generated from spoken words automatically by an analysis function from the conversation between the parties to the connection.

26: The system recited in claim 23, wherein the search function includes a search engine that searches the data volume, the data volume including a web page that is accessible via a World Wide Web.
